(19) United States
(12) Patent Application Publication
(10) Pub. No.: US 2007/0073950 A1
(43) Pub. Date: Mar. 29, 2007

(54) Personal memory device structure

(76) Inventor: Chung-Ching Sheng, Tu-Cheng City (TW)

Correspondence Address: TROXELL LAW OFFICE PLLC, SUITE 1404, 5205 LEESBURG PIKE, FALLS CHURCH, VA, 22041, US

(21) Appl. No.: 11/234,164

(22) Filed: Sep. 26, 2005

(51) Int. Cl. G06F 13/00

(52) U.S. Cl. 710/301

(57) ABSTRACT

A personal memory device structure includes primarily a personal memory device, a middle cap, and a penholder, wherein a USB plug is extended outward at a periphery of the personal memory device, and a holding space and a hole are located at a periphery of the middle cap. The holding space is used to hold the USB plug of the personal memory device, and the hole can be used to contain a pen-point protruded at one end of the penholder. A convex part can be located at the other end of penholder, which can be applied to a PDA or other touch-screen devices. When collecting the penholder and the personal memory device, they can be assembled with the middle cap to form a design of a model in an overall appearance.

### BACKGROUND OF THE INVENTION

1. Field of the Invention

The present invention relates to an improved structure of a personal memory device, and more particularly to a personal memory device which is provided with a function of pen and a design of an overall model.

2. Description of the Prior Art

As shown in FIG. 1, a conventional personal memory device (personal disk) is composed of a body of personal memory device 4 which is provided with a proper memory and is extended outward with an USB (Universal Serial Bus) plug 41 whose exterior side can be covered by a cap 42 in order to protect that USB plug 41.

However, the aforementioned structure of personal memory device (personal disk) is simply provided with a data storage function and can be easily carried, without any other additive function. In addition, there is no special innovation in its model of appearance, which is not easy to come out to attract consumers to purchase in an environment of strong competition of merchandise.

In view of the aforementioned drawbacks of the conventional personal memory device (personal disk), the inventor seeks to find a way of improvement to those drawbacks, thereby generating the present invention.

### SUMMARY OF THE INVENTION

The present invention is to provide an improved structure of a personal memory device comprising primarily a holding space and a hole located at a periphery of a middle cap. The holding space is used primarily to contain a USB plug which is extended outward from the personal memory device, and the hole can contain a pen-point which is protruded from one end of the penholder, such that the penholder and the personal memory device can be collected in the middle cap to be assembled into an integrated body. The primary object of the present invention is to provide multiple additive functions and a design of a model in an overall appearance to a personal memory device by matching the personal memory device, the middle cap, and the penholder, thereby improving a competitiveness of product.

Another object of the present invention is to enhance the additive function of a penholder by installing a convex part at the other end of the penholder, which can be applied to a PDA (Personal Digital Assistant) or other touch-screen devices.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of structure of a conventional personal memory device (personal disk).

FIG. 2 shows a perspective view upon decomposing the structure of the present invention.

FIG. 3 shows a perspective view of the present invention after being assembled.

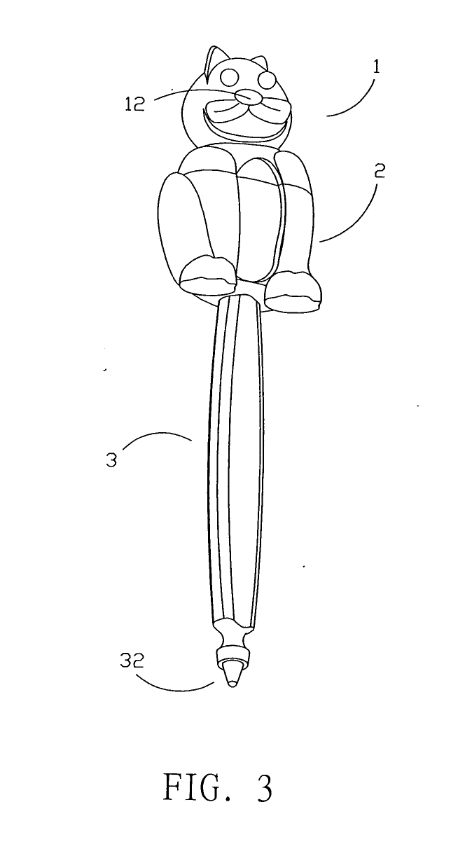

### DETAILED DESCRIPTION OF THE PREFERRED EMBODIMENTS

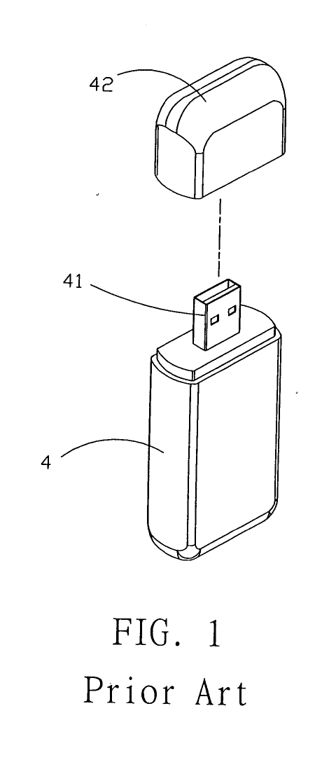

Referring to FIG. 1, it shows a conventional personal memory device (personal disk). As its primary components and drawbacks have been described above, there is no need to repeat here.

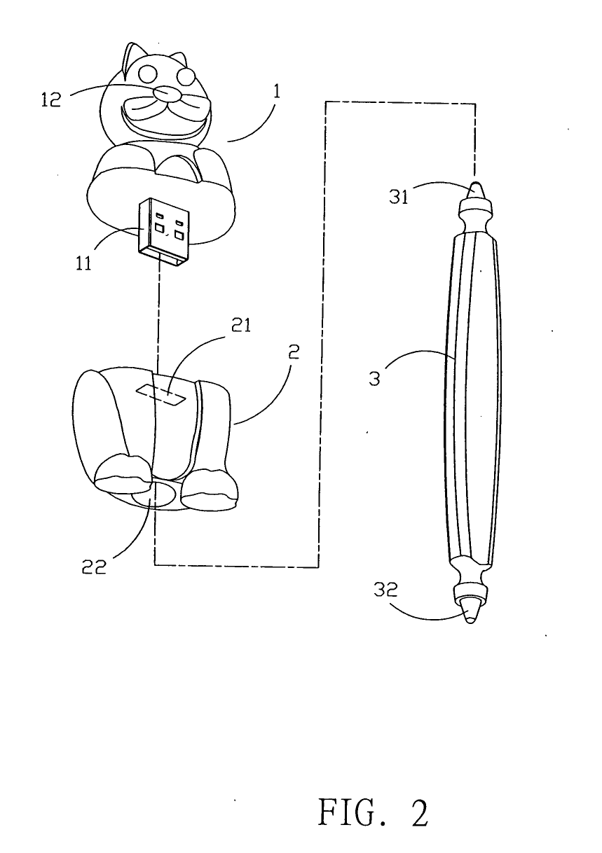

Referring to FIG. 2, which shows a perspective view upon decomposing the structure of the present invention, and FIG. 2, which shows a perspective view after assembling the present invention, the present invention includes primarily a personal memory device 1, a middle cap 2, and a penholder 3, wherein the personal memory device 1 contains a memory of a proper capacity which is connected with a USB plug 11 which is protruded outward at a periphery of the personal memory device 1, and a holding space 21 and a hole 22 are located at a periphery of the middle cap 2. In addition, a design of a model in an overall appearance (such as a cute animal, like an appearance of a cartoon cat in the drawing) is located between the personal memory device 1 and the middle cap 2, and an indicating light 12 is installed at a proper position on the personal memory device 1 for displaying a status of data accessing inside the personal memory device 1. A pen-point 31 combining with a pen core is protruded at one end of the penholder 3, and a convex part 32 can be installed at the other end of the penholder 3, which can be applied to a PDA or other touch-screen devices.

Upon assembling, the holding space 21 of the middle cap 2 is used to provide an insertion of the USB plug 11 of the personal memory device 1, and the hole 22 can be used to hold the pen-point 31 or the convex part 32 of the penholder 3. The present invention can be provided with multiple kinds of additive functions by matching the personal memory device 1, the middle cap 2, and the penholder 3. In addition, a model in an overall appearance can be formed by assembling the penholder 3 and the personal memory device 1 with the middle cap 2, after collecting the penholder 3 and the personal memory device 1, thereby increasing a competitiveness of product.

Accordingly, the personal memory device structure of the present invention is accurately provided with functions of writing and a touch-pen, and has a design of a model in an overall appearance, which is indeed provided with applicability, advancement, and improvement in the related industry.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A personal memory device structure including at least a personal memory device containing a proper memory and being able to be extended outward with a USB plug; a penholder containing at least one pen core which is protruded at one end of the penholder with a pen-point; a middle cap whose periphery is provided with a holding space and a hole, with the holding space being used to hold the USB plug of the personal memory device and the hole being used to contain the pen-point of the penholder, such that the penholder and the personal memory device can be collected to form an integrated body with the middle cap.

2. The personal memory device structure according to claim 1, wherein a convex part is located at the other end of the penholder, which can be applied to a PDA or other touch-screen devices.
